(19) United States
(12) Patent Application Publication
(10) Pub. No.: US 2003/0063546 A1
(43) Pub. Date: Apr. 3, 2003

(54) Information recording device, information recording method, information reproducing device, information reproducing method, record medium, and information record medium with programs computer-readably recorder

(75) Inventors: Takao Sawabe, Tokorozawa-shi (JP); Masanori Nakahara, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/254,766

(22) Filed: Sep. 26, 2002

(30) Foreign Application Priority Data
Sep. 28, 2001 (JP) P2001-303349

(51) Int. Cl. G11B 7/0045

(52) U.S. Cl. 369/59.25

(57) ABSTRACT

Objects that should be recorded to a DVD 1 are recorded to the DVD 1, individual time difference information LOST that indicates a time difference to be applied to a recorded object is recorded for each object, and time zone information TZ that is standardized as the time difference corresponding to all objects recorded on a DVD 1 is recorded so that it has content indicating that individual time difference information LOST is recorded independently of time zone information TZ.

### BACKGROUND OF THE INVENTION

1. Field of the Invention

The invention relates to the technical field of an information recording device, an information recording method, an information reproducing device, an information reproducing method, a record medium, an information record medium with a program computer-readably recorded thereon, and a program, and more particularly, to the technical field of an information recording device and an information recording method for recording multiple pieces of recorded information such as images corresponding to distinct time differences on a record medium such as an optical disk; an information reproducing device and an information reproducing method for reproducing each piece of recorded information recorded on a record medium by the information recording device etc.; a record medium itself; and information record medium on which programs for the information recording and reproducing are recorded in a computer-readable manner.

2. Description of the Related Art

In recent years, research and development relating to DVD (Digital Versatile Disc) which can record recorded information such as a movie in a compressed state have been extensively carried out, and standardization of recordable DVD as well as read-only DVD is in progress. As well, as a part of the standard for recordable DVD, the development of a standard for recording information shot by a video camera on the spot (that is, in real time) is also under way, which is intended to be used for an application such as video camera for example.

The standard for real-time recording thus far developed specifies that recording start time information indicating a time at which recording operation for each piece of recorded information starts is recorded concurrently with the recorded information, based on either a standard time used in a country or area where the real-time recording occurs should correspond to (hereafter referred to simply as a local standard time) or Greenwich Mean Time (GMT).

Correspondingly, the standard for real-time recording specifies that standard time information (generally sometimes referred to as time zone information) indicating a standard time (i.e. either a local standard time or GMT) which recording start time information corresponding to each piece of recorded information recorded on a DVD conforms to should be recorded independently of recording start time information.

More specifically, the standard time information includes type information that indicates whether the recording start time information currently recorded on a DVD corresponding to each piece of recorded information is recorded in GMT or a local standard time, and time difference information that indicates a corresponding time difference from GMT in the case where recording start time information is recorded in a local standard time.

And the current standard for real-time recording specifies that the only one piece of standard time information per DVD that should be commonly applied to all recorded information recorded on a DVD is described.

At the same time, information recording devices (hereinafter referred to simply as recorders) which are used to record recorded information onto recordable DVDs have been finding global use in recent years, and each of such recorders stores in advance recorder time difference information that indicates the time difference from GMT of a local standard time for a country or area where the recorder should be used. And as recorders of this kind are getting widely available, such a case is possible where multiple pieces of recorded information that are recorded in different countries or areas coexist on a single DVD.

However, since only one piece of standard time information corresponds to one DVD in the conventional standard for real-time recording as described above, inconveniences as described below occur when recorded information recorded in different countries or areas must coexist on a DVD in accordance with the standard.

That is, firstly as shown in FIG. 10A, if the content of corresponding type information is described in “Greenwich Mean Time”, that is, the recording start time information for each piece of recorded information is described in GMT, and the first recorded information is recorded in Japan at 9:00 a.m. in Japan time to a DVD whose content of time difference information is accordingly “0 minutes” by a recorder for Japan, namely a recorder that has recorder time difference information of “+540 minutes”, the content of recording start time information for the first recorded information will be:

the recording start time information for the first recorded information=recording time in Japan(9:00)+[time difference information (0 minutes)−recorder time difference information (+540 minutes)] thus will be recorded as “0:00” to the record medium.

Then, as shown in FIG. 10A, if the second recorded information is recorded at 12:00 a.m. in U.K. time by a recorder for U.K., namely a recorder having recorder time difference information of “±0 minutes”, onto the DVD on which the first recorded information is already recorded, the content of recording start time information for the second recorded information will be:

the recording start time information for the second recorded information=the recording time in U.K. (12:00)+[time difference information (0 minutes)−recorder time difference information (±0 minutes)] thus will be recorded as “12:00” to the record medium.

And as shown in FIG. 10B, if the first recorded information and second recorded information are reproduced by a recorder for Japan from the DVD on which the first recorded information and second recorded information are thus recorded, and at this point recording start times are displayed based on the recording start time information recorded for each piece of recorded information, the recording start time for the first recorded information will be:

the recording start time for the first recorded information=the recorded recording start time (0:00)−[time difference information (0 minutes)−recorder time difference information (+540 minutes)] thus will be correctly displayed as “9:00”. Whereas the recording start time for the second recorded information recorded in U.K. will be:

the recording start time for the second recorded information=the recorded recording start time (12:00)−[time difference information(0 minutes)−recorder time difference information (+540 minutes)] thus will be displayed as “21:00”. As a result, a trouble is encountered that content as the second recorded information such as images is of 12:00 of daytime whereas its recording start time is displayed as 21:00.

On the other hand, if the first recorded information and second recorded information are similarly reproduced by a recorder for U.K. from the DVD on which the first recorded information and second recorded information are recorded, and at this point their recording start times are displayed based on the recording start time information recorded for each piece of recorded information, as shown in FIG. 10B, the recording start time for the second recorded information in turn will be:

the recording start time for the second recorded information=the recorded recording start time (12:00)−[time difference information (0 minutes)−recorder time difference information (±0 minutes)] thus will be correctly displayed as “12:00”. Whereas the recording start time for the first recorded information recorded in Japan will be:

the recording start time for the first recorded information=the recorded recording start time (0:00)−[time difference information (0 minutes)−recorder time difference information (±0 minutes)] thus will be displayed as “0:00”. As a result, a trouble is encountered that content as the first recorded information such as images is of 9:00 a.m. of daytime whereas its recording start time is displayed as 0:00 of nighttime.

Secondly, as shown in FIG. 10C, if the content of corresponding type information is described in a “local standard time”, that is, the recording start time information for each piece of recorded information is described in a local standard time, and the first recorded information is recorded in Japan at 9:00 a.m. in Japan time by a recorder for Japan onto a record medium whose content of time difference information is accordingly a value representing the recorder time difference information corresponding to the recorder used in recording initial recorded information, the content of recording start time for the first recorded information will be:

the recording start time information for the first recorded information=the recording time in Japan (9:00)+[time difference information (+540 minutes)−recorder time difference information (+540 minutes)] thus will be recorded as “9:00” to the record medium. And additionally the time difference information for the entire record medium will be recorded as “+540 minutes” which represents the recorder time difference information.

Next, as shown in FIG. 10C, if the second recorded information is recorded at 12:00 a.m. in U.K. time onto the record medium on which the first recorded information is already recorded, by a recorder for U.K., the content of recording start time information corresponding to the second recorded information will be:

the recording start time information for the second recorded information=the recording time in U.K. (12:00)+[time difference information (+540 minutes)−recorder time difference information (±0 minutes)] thus will be recorded as “21:00” to the record medium.

And as shown in FIG. 10D, if the first and second recorded information are reproduced by a recorder for Japan from the record medium on which the first recorded information and second recorded information have been recorded in the above way, and at this point their recording start times are displayed based on the recording start time information recorded for each piece of recorded information, the recording start time for the first recorded information will be:

the recording start time information for the first recorded information=the recorded recording start time (9:00)−[time difference information (+540 minutes)−recorder time difference information (+540 minutes)] thus will be correctly displayed as “9:00”. Whereas the recording start time for the second recorded information recorded in U.K. will be:

the recording start time information for the second recorded information=the recorded recording start time (21:00)−[time difference information (+540 minutes)−recorder time difference information (+540 minutes)] thus will be displayed as “21:00”. As a result, a trouble is encountered that content as the second recorded information such as images is of daytime whereas its recording start time is displayed as 21:00.

On the other hand, if the first recorded information and second recorded information are similarly reproduced by a recorder for U.K. from the DVD on which the first recorded information and second recorded information are recorded, and at this point their recording start times are displayed based on the recording start time information recorded for each piece of recorded information, as shown in FIG. 10D, the recording start time for the second recorded information in turn will be:

the recording start time information for the second recorded information=the recorded recording start time (21:00)−[time difference information (+540 minutes)−recorder time difference information (±0 minutes)] thus will be correctly displayed, as “12:00”. Whereas, the recording start time for the first recorded information recorded in Japan will be:

the recording start time information for the first recorded information=the recorded recording start time (9:00)−[time difference information (+540 minutes)−recorder time difference information (±0 minutes)] thus will be displayed as “0:00”. As a result, a trouble is encountered that content as the first recorded information such as images is of 9:00 a.m. of daytime whereas its recording start time is displayed as 0:00 of nighttime.

### SUMMARY OF THE INVENTION

The invention was made in view of such inconveniences and has the object of providing the followings: an information recording device and an information recording method which can manage time differences for each piece of recorded information in a consistent way and display correct recording start times even in a case multiple pieces of recorded information corresponding to different time differences are recorded on a single record medium; an information reproducing device and an information reproducing method for reproducing recorded information recorded on a record medium by the information recording device or the like; a record medium itself; and an information record medium on which the program for the information recording and reproducing is recorded in a computer-readable manner.

The above object of the present invention can be achieved by an information recording device of the present invention. The information recording device is provided with: a recording device for recording recorded information onto a record medium; an individual area time difference information recording device for recording individual area time difference information onto said record medium, the individual area time difference information indicating a time difference to be applied to said recorded information for each piece of recorded information; a general area time difference information recording device for recording specific general time difference information onto said record medium, the specific general time difference information indicating that said individual area time difference information is recorded on said record medium; and an input device for inputting said individual area time difference information based on the time difference to be applied to said recorded information to be recorded.

According to the present invention, by recording individual area time difference information for each piece of recorded information and also recording general area time difference information as specific general time difference information, it is possible to correctly manage time differences to be applied to each piece of the recorded information based on the content of specific general time difference information, even when multiple pieces of recorded information that correspond to distinct time differences are recorded on a single record medium.

In one aspect of the present invention can be achieved by the information recording device of the present invention. The information recording device is provided with: a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information; a recording device for recording said additional recorded information onto said record medium; and an individual area time difference information recording device for recording individual area time difference information onto said record medium.

According to the present invention, by rewriting the content of general area time difference information to specific general time difference information and also recording individual area time difference information associated with additional recorded information when additional recorded information is recorded that should correspond to a time difference distinct from the one indicated by the general area time difference information, it is possible to correctly manage time differences to be applied to each piece of recorded information based on the content of specific general time difference information, even when multiple pieces of recorded information that should correspond to distinct pieces of area time difference information are recorded on a record medium.

In another aspect of the present invention can be achieved by the information recording device of the present invention. The information recording device is, wherein said rewriting device records said individual area time difference information onto said record medium that indicates a time difference to be applied to said other pieces of recorded information already recorded on said record medium independently of said specific general time difference information.

According to the present invention, by separately recording individual area time difference information that should be applied to other pieces of recorded information already recorded, it is possible to correctly manage time differences for other pieces of recorded information that are already recorded as well.

In further aspect of the present invention can be achieved by the information recording device of the present invention. The information recording device is further provided with an input device for inputting said individual area time difference information based on the time difference to be applied to said recorded information to be recorded.

According to the present invention, since corresponding individual area time difference information can be input, it is possible to set and use a correct time difference even when different pieces of recorded information are recorded in areas that should correspond to distinct time differences.

The above object of the present invention can be achieved by an information reproducing device of the present invention. The information reproducing device for reproducing each piece of recorded information from a record medium, the record medium is provided with: recorded information recording area on which each piece of said recorded information is recorded; individual area time difference information recording area on which individual area time difference information, the individual area time difference information indicating a time difference to be applied to said recorded information for each piece of recorded information; and general area time difference information recording area on which specific general time difference information is recorded, the specific general time difference information indicating that said individual area time difference information is recorded on said record medium; said information reproducing device is provided with: an output device for outputting time information based on said individual area time difference information; and a verification device for verifying whether said specific general time difference information is recorded on said record medium or not.

According to the present invention, by detecting individual area time difference information when it is recognized that specific general time difference information is recorded, and outputting time information corresponding to the individual area time difference information based on the detected information, it is possible to output and use correct time information that corresponds to recorded information to be reproduced, even when any piece of recorded information is reproduced from a record medium on which multiple pieces of recorded information that should correspond to distinct time differences are recorded.

The above object of the present invention can be achieved by an information recording method of the present invention. The information recording method is provided with: a recording step of recording recorded information onto a record medium; an individual area time difference information recording step of recording individual area time difference information onto said record medium, the individual area time difference information indicating a time difference to be applied to said recorded information for each piece of the recorded information; a general area time difference information recording step of recording specific general time difference information onto said record medium, the specific general time difference information indicating that said individual area time difference information is recorded on said record medium; and an input step of inputting said individual area time difference information based on the time difference to be applied to said recorded information to be recorded.

According to the present invention, by recording individual area time difference information for each piece of recorded information and also recording general area time difference information as specific general time difference information, it is possible to correctly manage time differences to be applied to each piece of recorded information based on the content of specific general time difference information, even when multiple pieces of recorded information that correspond to distinct time differences are recorded to a record medium.

In one aspect of the present invention can be achieved by the information recording method of the present invention. The information recording method is provided with: a rewriting step of, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information; a recording step of recording said additional recorded information onto said record medium; and an individual area time difference information recording step of recording individual area time difference information onto said record medium.

According to the present invention, by rewriting the content of general area time difference information to specific general time difference information when additional recorded information is recorded that should correspond to a time difference distinct from the one indicated by general area time difference information, and also recording individual area time difference information associated with the additional recorded information, it is possible to correctly manage time differences to be applied to each piece of recorded information based on the content of specific general time difference information, even when multiple pieces of recorded information that should correspond to distinct pieces of area time difference information are recorded to a record medium.

In another aspect of the present invention can be achieved by the information recording method of the present invention. The information recording method is, wherein said rewriting step records said individual area time difference information onto said record medium that indicates a time difference to be applied to said other pieces of recorded information already recorded on said record medium independently of said specific general time difference information.

According to the present information, by separately recording the individual area time difference information which other recorded information already recorded should correspond to, it is possible to manage time differences correctly also for other recorded information already recorded.

In further aspect of the present invention can be achieved by the information recording method of the present invention. The information recording method is further provided with an input step of inputting said individual area time difference information based on the time difference to be applied to said recorded information to be recorded.

According to the present information, by inputting corresponding individual area time difference information, it is possible to set and use a correct time difference even when different pieces of recorded information are recorded in areas that correspond to distinct time differences.

The above object of the present invention can be achieved by an information reproducing method of the present invention. The information reproducing method for reproducing each piece of recorded information from a record medium, the record medium is provided with: recorded information recording area on which each piece of said recorded information is recorded; individual area time difference information recording area on which individual area time difference information, the individual area time difference information indicating a time difference to be applied to said recorded information for each piece of recorded information; and general area time difference information recording area on which specific general time difference information is recorded, the specific general time difference information indicating that said individual area time difference information is recorded on said record medium; said information reproducing method is provided with: an output step of outputting time information based on said individual area time difference information; and a verification step of verifying whether said specific general time difference information is recorded on said record medium or not.

According to the present invention, by detecting individual area time difference information when it is recognized that specific general time difference information is recorded and outputting time information that corresponds to the individual area time difference information based on the detected information, it is possible to output and use correct time information corresponding to recorded information to be reproduced, even when any piece of recorded information is reproduced from a record medium on which multiple pieces of recorded information that should correspond to distinct time differences are recorded.

The above object of the present invention can be achieved by an information record media of the present invention. The information record medium on which a record controlling program is recorded being readable by a recording computer that is included in an information recording device, said program causing said recording computer to function as: a recording device for recording recorded information onto a record medium; individual area time difference information recording device for recording individual area time difference information onto said record medium, the individual area time difference information indicating a time difference to be applied to said recorded information for each piece of recorded information; a general area time difference information recording device for recording specific general time difference information onto said record medium, the specific general time difference information indicating that said individual area time difference information is recorded on said record medium; and an input device for inputting said individual area time difference information based on the time difference to be applied to said recorded information to be recorded.

According to the present invention, since the recording computer functions such that it records the individual area time difference information for each piece of recorded information and also records general area time difference information as specific general time difference information, it is possible to correctly manage time differences to be applied to each piece of recorded information based on the content of specific general time difference information, even when multiple pieces of recorded information that should correspond to distinct time differences are recorded to a record medium.

In one aspect of the present invention can be achieved by the information record media of the present invention. The information record medium on which a record controlling program is recorded being readable by a recording computer that is included in an information recording device, said program causing said recording computer to function as: a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information; a recording device for recording said additional recorded information onto said record medium; and an individual area time difference information recording device for recording individual area time difference information onto said record medium.

According to the present invention, since the recording computer functions such that it rewrites the content of general area time difference information to specific general time difference information when additional recorded information is recorded that should correspond to a time difference distinct from the one indicated by general area time difference information, and also records individual area time difference information associated with the additional recorded information, it is possible to correctly manage time differences to be applied to each piece of recorded information based on the content of specific general time difference information, even when multiple pieces of recorded information that should correspond to distinct pieces of area time difference information are recorded to a record medium.

In another aspect of the present invention can be achieved by the information record media of the present invention. The information record medium is, wherein said rewriting device records said individual area time difference information onto said record medium that indicates a time difference to be applied to said other pieces of recorded information already recorded on said record medium independently of said specific general time difference information.

According to the present invention, since the recording computer functions such that it separately records individual area time difference information that other pieces of recorded information already recorded should correspond to, it is possible to manage time differences correctly also for other recorded information already recorded.

In further aspect of the present invention can be achieved by the information record media of the present invention. The information record medium is, wherein said record controlling program is recorded on the information record medium being readable by said recording computer, said record controlling program causing said recording computer to further function as input device for inputting said individual area time difference information based on the time difference to be applied to said recorded information to be recorded.

According to the present invention, since the recording computer functions such that corresponding individual area time difference information can be input, it is possible to set and use a correct time difference even when different pieces of recorded information are recorded in areas that correspond to distinct time differences.

In further aspect of the present invention can be achieved by the information record media of the present invention. The information record medium on which a reproduction controlling program is recorded being readable by a reproducing computer that is included in an information reproducing device which reproduces each piece of recorded information from a record medium, the record medium is provided with: recorded information recording area on which each piece of said recorded information is recorded; individual area time difference information recording area on which individual area time difference information, the individual area time difference information indicating a time difference to be applied to said recorded information for each piece of recorded information; and general area time difference information recording area on which specific general time difference information is recorded, the specific general time difference information indicating that said individual area time difference information is recorded on said record medium; said reproduction controlling program causing said reproducing computer to function as: an output device for outputting time information based on said individual area time difference information; and a verification device for verifying whether said specific general time difference information is recorded on said record medium or not.

According to the present invention, since the reproducing computer functions such that it detects individual area time difference information when recording of specific general time difference information is recognized and it outputs time information corresponding to the detected individual area time difference information based on the information, it is possible to output and use correct time information corresponding to recorded information to be reproduced, even when any piece of recorded information is reproduced from a record medium on which multiple pieces of recorded information that should correspond to distinct time differences are recorded.

The above object of the present invention can be achieved by an record controlling program of the present invention. The record controlling program embodied on computer-readable medium for causing a recording computer included in an information recording device to function as: a recording device for recording recorded information onto a record medium; an individual area time difference information recording device for recording individual area time difference information onto said record medium, the individual area time difference information indicating a time difference to be applied to said recorded information for each piece of recorded information; a general area time difference information recording device for recording specific general time difference information onto said record medium, the specific general time difference information indicating that said individual area time difference information is recorded on said record medium; and an input device for inputting said individual area time difference information based on the time difference to be applied to said recorded information to be recorded.

According to the present invention, since the recording computer functions such that it records individual area time difference information for each piece of recorded information and also records general area time difference information as specific general time difference information, it is possible to correctly manage time differences to be applied to each piece of recorded information based on the content of specific general time difference information, even when multiple pieces of recorded information that should correspond to distinct time differences are recorded on a single record medium.

In one aspect of the present invention can be achieved by the record controlling program of the present invention. The record controlling program embodied on computer-readable medium for causing a recording computer included in an information recording device to function as: a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information; a recording device for recording said additional recorded information onto said record medium; and an individual area time difference information recording device for recording individual area time difference information onto said record medium

According to the present invention, since the recording computer functions such that it rewrites the content of general area time difference information to specific general time difference information when it records additional recorded information that should correspond to a time difference distinct from the one indicated by general area time difference information and it also records individual area time difference information associated with the additional recorded information, it is possible to correctly manage time differences to be applied to each of recorded information based on the content of specific general time difference information, even when multiple pieces of recorded information that should correspond to distinct pieces of area time difference information are recorded to a single record medium.

In another aspect of the present invention can be achieved by the record controlling program of the present invention. The record controlling program embodied on computer-readable medium is, wherein the record controlling program causes said recording computer to function as said rewriting device for recording individual area time difference information onto said record medium that indicates a time difference to be applied to other pieces of said recorded information already recorded on said record medium independently of said specific general time difference information.

According to the present invention, since the recording computer functions such that it separately records individual area time difference information that other recorded information already recorded should correspond to, it is possible to manage time differences correctly also for other recorded information already recorded.

In further aspect of the present invention can be achieved by the record controlling program of the present invention. The record controlling program embodied on computer-readable medium is, wherein the record controlling program causes said recording computer to further function as input device for inputting said individual area time difference information based on a time difference to be applied to said recorded information to be recorded.

According to the present invention, since the recording computer functions such that corresponding individual area time difference information can be input, it is possible to set and use a correct time difference even when different pieces of recorded information are recorded in areas that correspond to distinct time differences.

The above object of the present invention can be achieved by an reproduction controlling program of the present invention. The reproduction controlling program embodied on computer-readable medium for causing a reproducing computer that is included in an information reproducing device for reproducing each piece of said recorded information from said record medium, the record medium is provided with: recorded information recording area on which each piece of said recorded information is recorded; individual area time difference information recording area on which individual area time difference information, the individual area time difference information indicating a time difference to be applied to said recorded information for each piece of recorded information; and general area time difference information recording area on which specific general time difference information is recorded, the specific general time difference information indicating that said individual area time difference information is recorded on said record medium; said reproduction controlling program causing said reproducing computer to function as: an output device for outputting time information based on said individual area time difference information; and a verification device for verifying whether said specific general time difference information is recorded on said record medium or not.

According to the present invention, since the reproducing computer functions such that it detects individual area time difference information when recording of specific general time difference information is recognized and it outputs time information corresponding to the detected individual area time difference information based on the information, it is possible to output and use correct time information corresponding to recorded information to be reproduced, even when any piece of recorded information is reproduced from a record medium on which multiple pieces of recorded information that should correspond to distinct time differences are recorded.

The above object of the present invention can be achieved by a record media of the present invention. The record medium is provided with: recorded information recording area on which each piece of said recorded information is recorded; individual area time difference information recording area on which individual area time difference information, the individual area time difference information indicating a time difference to be applied to said recorded information for each piece of recorded information; and general area time difference information recording area on which specific general time difference information is recorded, the specific general time difference information indicating that said individual area time difference information is recorded on said record medium.

According to the present information, since individual area time difference information corresponding to each piece of recorded information is recorded along with specific general time difference information, it is possible to output and use correct time information corresponding to recorded information to be reproduced, even when any piece of recorded information is reproduced from a record medium on which multiple pieces of recorded information that should correspond to different pieces of individual area time difference information are recorded.

### BRIEF DESCRIPTION OF THE DRAWINGS

FIG. 1 illustrates the recording format in the DVD according to an embodiment;

FIG. 2 is a block diagram showing the general configuration of the recorder/player according to the embodiment;

FIG. 3 is a flow chart showing the time zone setting according to the embodiment;

FIG. 4 is a flow chart showing the recording according to the embodiment;

FIG. 5 is a flow chart showing the time displaying according to the embodiment;

FIG. 6 is a diagram (I) showing the instantiation of recording and the like according to the embodiment;

FIG. 7 is a diagram (II) showing the instantiation of recording and the like according to the embodiment;

FIG. 8 is a diagram (III) showing the instantiation of recording according to the embodiment;

FIG. 9 is a diagram (IV) showing the instantiation of recording and the like according to the embodiment; and

FIG. 10 is diagram showing the conventional problem: FIG. 10A is a diagram (I) showing the problem; FIG. 10B is a diagram (II) showing the problem; FIG. 10C is a diagram (III) showing the problem; and FIG. 10D is a diagram (IV) showing the problem.

### DETAILED DESCRIPTION OF THE PREFERRED EMBODIMENTS

In the following, a preferred embodiment of the invention will be described based on the drawings.

The following description addresses an embodiment in which the invention is applied to an information recording and reproducing device (hereafter referred to simply as recorder/player) which can record recorded information in countries or areas that correspond to different time differences onto a DVD as rewritable record medium and also can reproduce the recorded information.

(I) The Embodiment of Recording Format

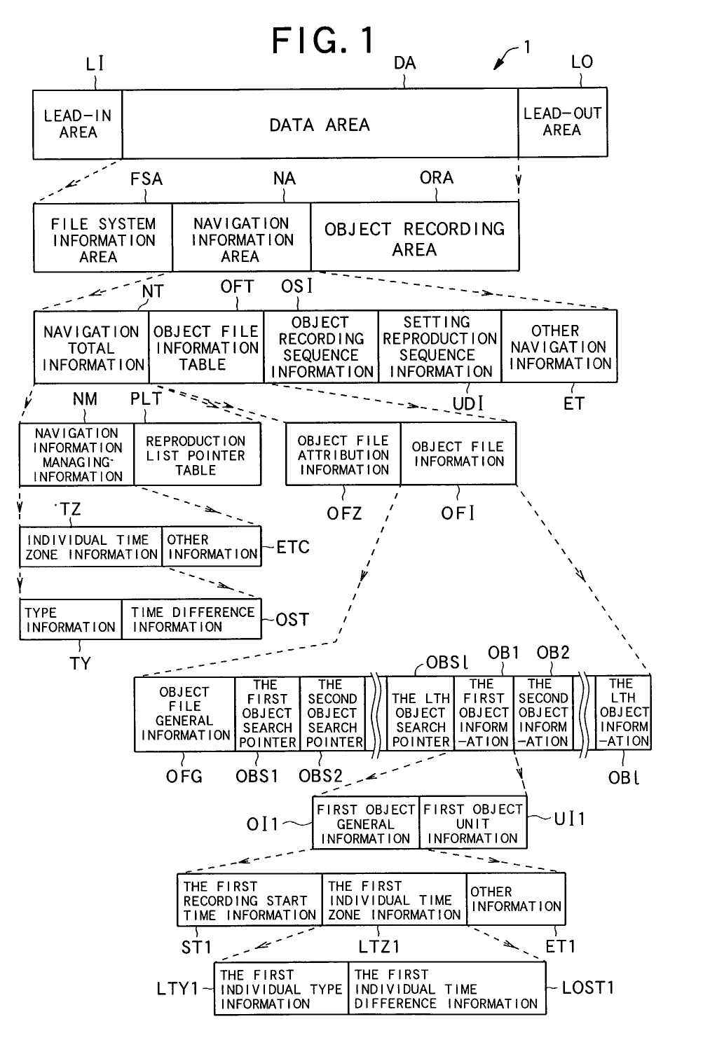

Before describing the embodiment of the recorder/player according to the invention, the recording format that is applied in recording multiple pieces of recorded information corresponding to different time differences to a DVD by means of the recorder/player will be first described with FIG. 1.

FIG. 1 shows a physical format as recording format (that is, a physical format showing record locations within a DVD of each piece of information including recorded information to be recorded).

As shown in FIG. 1, the physical format on a DVD according to the invention is as follows. On a rewritable DVD 1 (specifically, a DVD-RW (DVD-Re-recordable) or the like capable of multiple rewritings), the following areas are formed from its innermost: lead-in area LI which records start information and the like as control information for starting the reproduction of information on the DVD 1; data area DA which records reproduction control information for controlling recorded information which is actually reproduced and the aspects of reproduction (specifically, information which indicates the order and duration of reproduction, or record location on the DVD 1 for each piece of information constituting the recorded information); and lead-out area LO which records termination information and the like as control information for terminating the reproduction of recorded information.

In the data area DA, file system information area FSA, navigation information area NA, and object recording area ORA are formed.

In the object recording area ORA, multiple pieces of information to be recorded are recorded as objects. In this process, a sequence of recorded information that is recorded between the start of recording and its end corresponds to an object immediately after the recording. In other words, one object will be formed in the object recording area ORA every time recording of continuous recorded information terminates.

In the navigation information area NA in the data area DA, reproduction control information is recorded as navigation information for controlling the aspects of reproducing the objects recorded in the object recording area ORA, as will be described.

Finally, in the file system information area FSA, system information for storing the navigation information in the navigation information area NA hierarchically in a so-called file format is recorded.

Next, as navigation information in the navigation information area NA, navigation total information NT, object file information table OFT, object recording sequence information OSI, configured play sequence information UDI, and other navigation information ET are recorded.

The navigation total information NT consists of navigation information management table NM (so-called general information) that serves as total information on the DVD 1 for managing storage location (record location) within the navigation information area NA of each piece of sequence information (information that indicates the order of reproduction in information unit constituting one object) or of an information table and record starting location of the object recording area ORA; and play list pointer table PLT that indicates the correspondence between navigation information stored in configured play sequence information UDI and a so-called play list (referred to as Play List (PL) in the DVD standard).

The object file information table OFT consists of object file attribute information OFZ that is information on the types of objects recorded in the object recording area ORA (specifically, audio object containing audio information and video object containing images, etc.) and on attributes relevant to the types; and object file information OFI that comprises recording start time and ending time for each object and relevant information and the like.

Moreover, the object file information OFI consists of the followings: object file general information OFG which records various information about one or more objects currently recorded on the DVD 1, specifically, includes total number of objects on the DVD 1 at the present time; one (one denotes the number of objects currently recorded in the DVD 1) object search pointer OBS which describes information about address of start of each object that should be a target for search (play) during playback described later; and one piece of (that is, of equal number as the object search pointer OBS) object information OB which describes address information indicating the record location of the start of each object on the DVD 1.

Still further, each object information OB consists of object general information OI that comprises recording start time and ending time for each object and relevant information, and object unit information UI that is information on playback duration, record starting address or size of constituent units that constitute each object. In FIG. 1, the object general information OI1 and object unit information UI1 that correspond to the first object information OB are shown.

Each piece of object general information OI consists of recording start time information ST which describes the time at which recording of corresponding object (recorded information) onto the DVD 1 is started in either GMT or a local standard time as described in the following; individual time zone information LTZ that is information indicating a time difference that a country or area where corresponding object is recorded should correspond to; and other information ET that is additional information as object general information OI (including the above-mentioned record ending time of objects etc.).

The individual time zone information LTZ consists of individual type information LTY that indicates whether the individual time zone information LTZ itself is valid or not, and individual time difference information LOST that indicates a time difference which a country or area where corresponding object is recorded should correspond to.

Here, when individual time zone information LTZ corresponding to each object is valid, the value of individual type information LTY will be “01b” (b means binary number. The same applies to the following), and when individual time zone information LTZ is invalid, the value of individual type information LTY will be “00b”.

The object recording sequence information OSI is referred to as Original Program Chain (ORG-PGC) in the standard corresponding to the recording format of the DVD 1, and is information showing the recording sequences of each object altogether (namely, showing in which sequence what kind of recorded information has been originally recorded as corresponding objects to the DVD 1).

Both of the object file information table OFT and the object recording sequence information OSI are created or updated to be newly recorded every time a new object is recorded to the DVD 1. These pieces of information allow a user to reproduce each object in the same order and playback duration as they were at their recording.

The configured play sequence information UDI is referred to as User Defined Program Chain (UD-PGC) in the standard corresponding to the recording format of the DVD 1, and is information one or more of which a user generates and records in order to combine all or some of recorded objects freely of his/her own and reproduce them logically after recording objects, and is information recorded with a number every time the user configures it newly. At that point, a user defined program chain will be associated with an above-mentioned play list.

The other navigation information ET consists of information that is necessary for controlling reproduction other than each of navigation information described above.

Next, the navigation information management table NM consists of time zone information TZ that is standardized as the time zone information applied to all objects recorded on the DVD 1 according to the above standard, and other information ETC that includes information for managing the storage location within the navigation information area NA of sequence information or information table and the record starting location for the object recording area ORA.

And time zone information TZ includes type information TY that indicates whether each piece of recording start time information ST is described in GMT or a local standard time, and time difference information OST that indicates a time difference to be applied to all objects recorded in the DVD 1.

When each piece of recording start time information ST is described in GMT, the value of type information TY will be “0000h” (h denotes hexadecimal number. The same applies to the following). When each piece of recording start time information ST is described in a local standard time, the value will be “0001h”. And when each piece of recording start time information ST is recorded by a after-mentioned recorder/player S according to the embodiment (that is, when at least one recording process has been made to the DVD 1 by the recorder/player S), in other words when objects that should respectively correspond to distinct time differences might be recorded, the value will be “0010h” and the value of time difference information OST will be “0 minutes”. At this point, the type information TY having the value “0010h” is equivalent to the specific general time difference information described in the claims, and moreover, the type information TY having the value “0010h” and the time difference information OST having the value “0 minutes” are contained in the time zone information TZ that is equivalent to the general area time difference information described in the claims.

(II) The Embodiment of Recorder/player

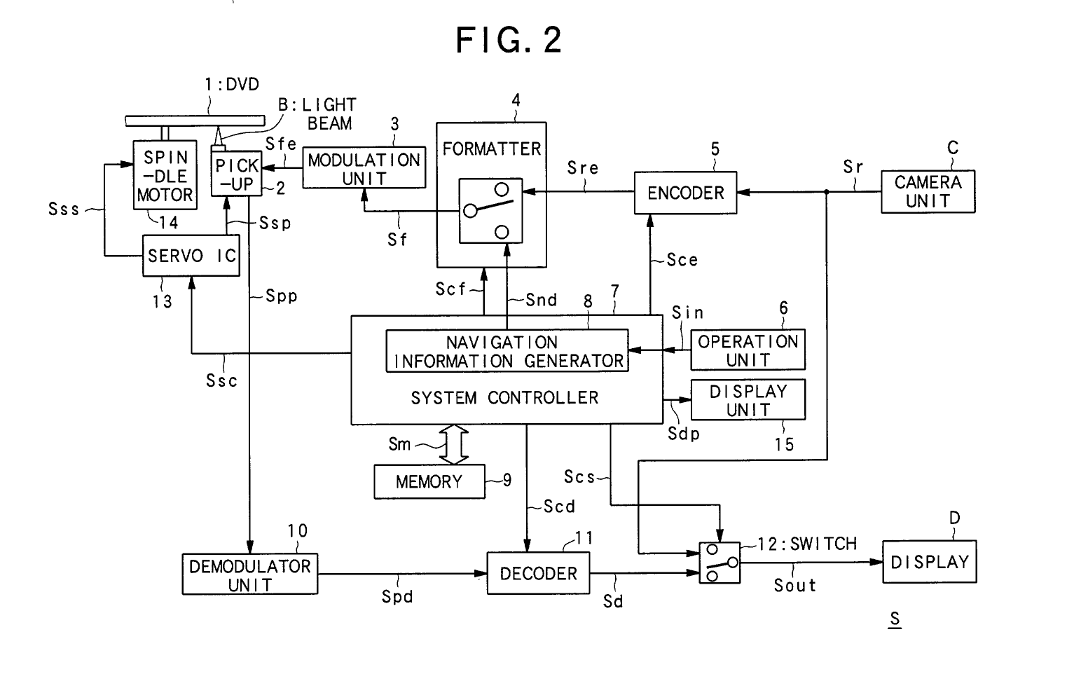

Now, the embodiment of the recorder/player according to the invention, which records objects to the DVD 1 according to the recording format described with FIG. 1 and reproduces them from the DVD 1, will be described with FIGS. 2 to 5. The recorder/player to be described is a recorder/player capable of recording objects using local standard times in various places in the world, and specifically, a recorder/player employed as so-called video camera.

The general configuration of the recorder/player according to the embodiment will be first described with FIG. 2. FIG. 2 is a block diagram illustrating the general configuration of the recorder/player.

As shown in FIG. 2, the recorder/player S according to the embodiment consists of a pickup 2 as recording device, a modulation unit 3, a formatter 4, an encoder 5, an operation unit 6 as input device, a system controller 7 as verification device, output device, rewriting device, individual area time difference information recording device, and general area time difference information recording device, memory 9, a demodulation unit 10, a decoder 11, a switch 12, a servo IC (Integrated Circuit) 13, a spindle motor 14, and a display unit 15.

The system controller 7 is provided with a navigation information generator 8.

The general operation of each element will be now described.

The spindle motor 14 rotates the DVD 1 with a predetermined number of rotation based on spindle control signal Sss from the servo IC 13.

Meanwhile, recorded information Sr including images or the like to be recorded to the DVD 1 is imaged and output by the camera unit C to be input to the encoder 5 and either input terminal of the switch 12.

The encoder 5, based on control signal Sce from the system controller 7, applies predetermined encoding (specifically, compressive encoding process of MPEG (Moving Picture Experts Group) standard for example) to the recorded information Sr and generates encoded signal Sre to be output to the formatter 4.

This causes the formatter 4 to, based on control signal Scf from the system controller 7, superimpose the after-mentioned navigation information signal Snd from the navigation information generator 8 and the encoded signal Sre in the recording (physical) format in FIG. 1 and generate superimposed signal Sf to be output to the modulation unit 3.

Then the modulation unit 3 applies predetermined modulation (specifically, so-called 8/16 modulating process for example) to the superimposed signal Sf and generates modulated signal Sfe to be output to the pickup 2.

This causes the pickup 2 to generate light beam B with its intensity modulated with the modulated signal Sfe and exposes it onto information tracks in information recording surface of the DVD 1 (not shown) to form pits in the tracks that correspond to the navigation information and recorded information contained in the modulated signal Sfe, thereby recording the navigation information and recorded information onto the DVD 1 in the recording format shown in FIG. 1.

At this point, vertical and horizontal displacement with the information recording surface between the converging point of the light beam B and an information track is eliminated by moving an objective lens in the pickup 2 (not shown. An objective lens for converging the light beam B) in vertical and horizontal directions based on the pickup servo signal Ssp output from the servo IC 13 (that is, by performing so-called focus servo control and tracking servo control).

For the purpose, the servo IC 13 generates the spindle control signal Sss and pickup servo signal Ssp based on the control signal Ssc from the system controller 7 and outputs them to the spindle motor 14 and the pickup 2 respectively.

Meanwhile, when reproducing recorded information that is already recorded on the DVD 1, the pickup 2 generates light beam B for reproduction having certain intensity and exposes it to the information tracks in which pits are formed, and based on reflected light from the pits, generates detection signal Spp corresponding to the recorded information and the like and outputs it to the demodulation unit 10.

This causes the demodulation unit 10 to apply demodulation that corresponds to the modulation by the modulation unit 3 to the detection signal Spp and generates demodulated signal Spd to be output to the decoder 11.

Then the decoder 11 applies decoding that corresponds to the encoding by the encoder 5 to the demodulated signal Spd according to control signal Scd from the system controller 7 and generates decoded signal Sd to be output to the other input terminal of the switch 12.

The switch 12 selects either the recorded information Sr or the decoded signal Sd based on control signal Scs from the system controller 7 and outputs it as output signal Sout to an external display D etc. If the switch 12 is switched to the camera unit C position, the content of recorded information Sr including images shot by the camera unit C will be simply displayed on the display D etc.

When a user performs operations for executing recording of objects in the recorder/player S and after-mentioned time zone setting for setting a country or area where the recorder/player S operates, the operation unit 6 generates operation signal Sin that corresponds to the operation and outputs it to the system controller 7 and the navigation information generator 8.

This causes the navigation information generator 8 to, based on the control signal Sin, generate the navigation information signal Snd containing each piece of above navigation information corresponding to the recorded information to be recorded, and outputs it to either input terminal of the formatter 4.

And the formatter 4 superimposes the recorded information in the encoded signal Sre and the navigation information in the navigation information signal Snd, thereby generating superimposed signal Sf containing recorded information and the like having the recording format shown in FIG. 1.

In parallel with these operations, the system controller 7 sends/receives necessary information as memory signal Sm to and from memory 9 while generating each of the control signals Sce, Scf, Scd, and Scs for controlling each of the operations above and outputting them to the corresponding components.

Also, information required to track operations in the recorder/player S including after-mentioned recording start time is output as display signal Sdp from the system controller 7 to the display unit 15 and displayed at the unit.

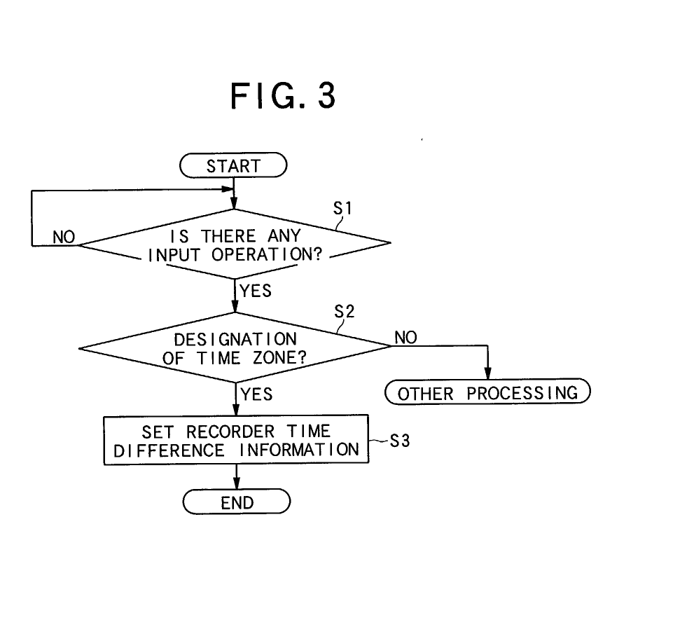

Next, recording process and the like according to the embodiment that is executed in the recorder/player S of the configuration described above will be described in detail with FIGS. 3 to 5.

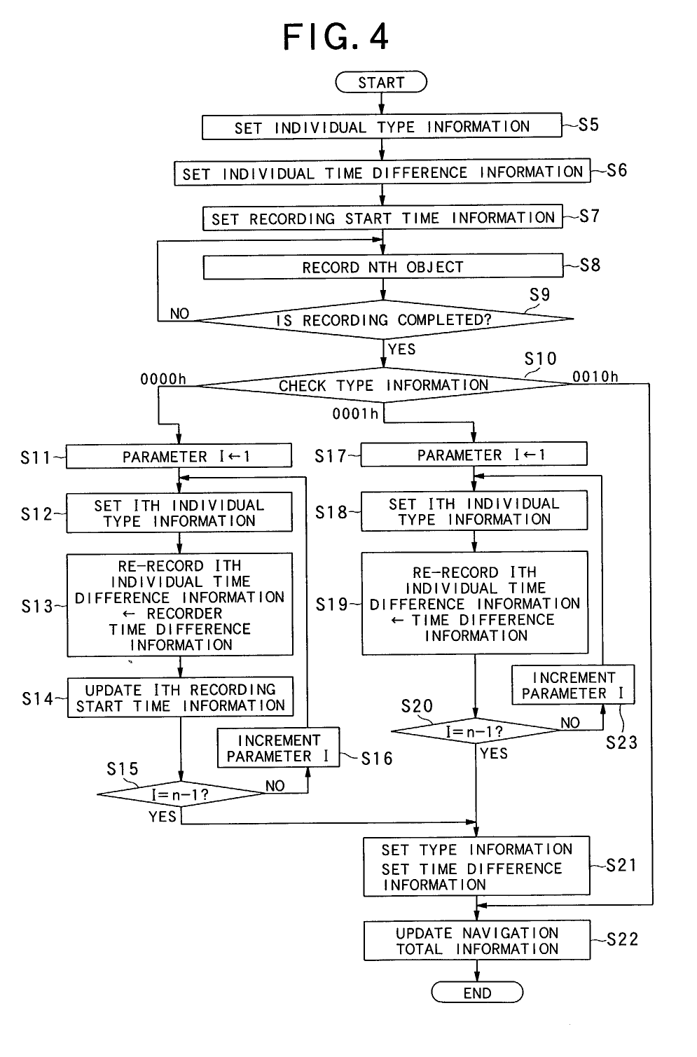

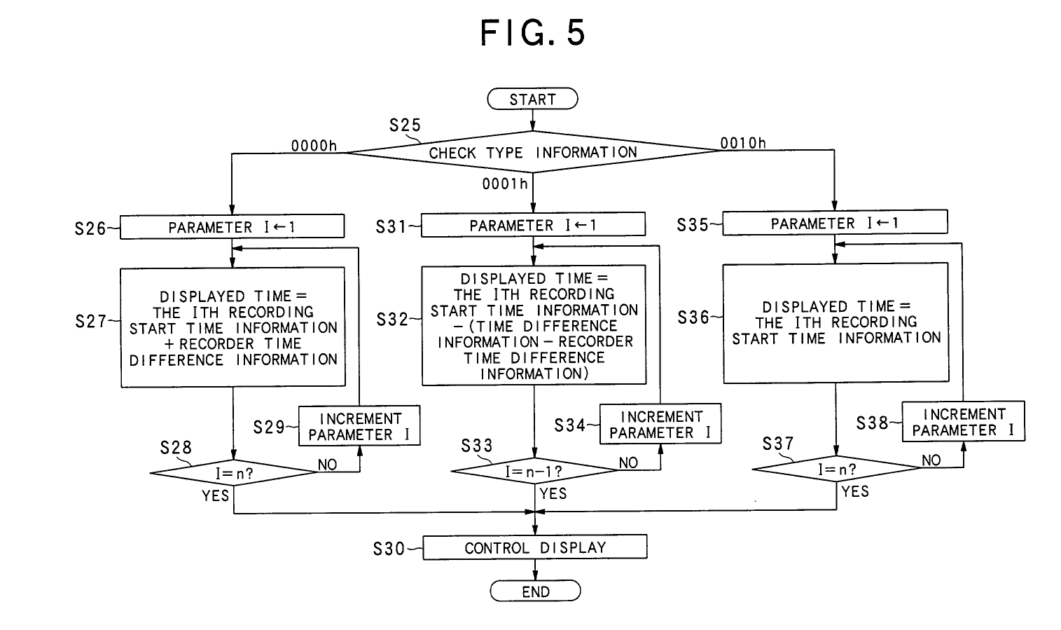

FIG. 3 is a flow chart showing the process for setting a time difference for a country or area where the recorder/player S according to the embodiment operates (hereafter referred to simply as time zone setting process), FIG. 4 is a flow chart showing recording process itself, and FIG. 5 is a flow chart showing the process for displaying a recording time that is executed in reproduction of recorded objects.

First, the time zone setting performed mainly by the system controller 7 prior to the execution of recording process of objects by the recorder/player S will be described with FIG. 3.

As shown, in the time zone setting according to the embodiment, first it is checked if any input operation has been performed at the operation unit 6 or not (step S1). If there is no input operation (step S1; NO) the state is maintained waiting for any operation, and if any input operation is made (step S1; YES) it is checked whether the operation is for time zone setting or not (step S2).

And if the input operation is not for time zone setting (step S2; NO) another process corresponding to the operation is performed, and if the input operation is for time zone setting (step S2; YES), the time difference between a local standard time that a specified country or area should correspond to and GMT is set as recorder time difference information in memory 9 (step S3) and the time zone setting according to the embodiment is completed.

Here, the difference set as recorder time difference information at step S3 is a time difference selected as one that corresponds to the country or area specified at the process of step S2 of FIG. 3 from the time differences for each country or area prestored in memory 9.

Now, object recording process according to the embodiment executed mainly by the system controller 7 will be described with FIG. 4.

As shown in FIG. 4, in the recording of recorded information according to the embodiment, individual type information LTY that corresponds to an object to be recorded in a country or area for which the time difference has been set in the process in FIG. 3 (following description supposes the object is an nth object to be recorded to a DVD 1 in all) is first set to “01b” and recorded (step S5). Then the value of corresponding individual time difference information LOST is recorded as the value of the recorder time difference information set in the process of step S3 of FIG. 3 (step S6), and the recording start time for the nth object is recorded as the corresponding recording start time information ST (step S7) and recording of the object is initiated (step S8).

During the recording of the object, it is monitored if the recording is complete or not all the time (step S9). And if the recording is not complete (step S9; NO) the recording continues, and if the recording is complete (step S9; YES), the content of type information TY thus far recorded in the DVD 1 is checked (step S10).

And if the value of type information TY turns out to be “0000h” by the check at step S10 (step S10; 0000h), other objects have already been recorded to the DVD 1 by another (conventional) recorder/player prior to the object recorded at the step S8, and the recording start time information ST for the prior objects has been described in GMT. Therefore, parameter i that indicates the number of one of the prior object is initialized (step S11), the value of individual type information LTY corresponding to the ith prior object is re-recorded as “01b” (step S12), and the value of individual time difference information LOST corresponding to the ith object is re-recorded as the value of recorder time difference information that was set in the process of step S3 in FIG. 3 (step S13). Further, recording start time information ST that has already been recorded in GMT is updated to be a value equivalent to recording start time in GMT plus the value of recorder time difference information, which indicates the recording start time corresponding to the ith prior object (step S14).

Then, it is checked whether the current value of parameter i has become “n−1” or not, that is, whether or not the processes of steps S12 to S14 have been completed for all the objects previously recorded on the DVD 1 (step S15). If the value of parameter i is not “n−1” (step S15; NO), the value of parameter i is incremented by just “one” (step S16) to return to step S12 so that each process of steps S12 to S14 is executed to unprocessed objects. Whereas if the current value of parameter i is “n−1” (step S15; YES), all the objects previously recorded have been processed with processes of steps S12 to S14. Thus, the value of type information TY which originally has been “0000h” is rewritten to the value of “0010h” indicating that recording process by the recorder/player S according to the embodiment has been performed at least once, and also the value of time difference information OST is rewritten to a value not significant (step S21). Further, values in other navigation total information NT are rewritten to corresponding values (step S22), which completes the recording process according to the embodiment.

Meanwhile, if the value of type information TY is “0001h” at step S10 (step S10; 0001h), other objects have already been recorded on the DVD 1 by another recorder/player prior to the object recorded at step S8, and the recording start time information ST for the prior objects has been described in a local standard time. Therefore, the parameter i indicating the number of one of the prior object is then initialized (step S17), the value of individual type information LTY corresponding to the ith prior object is re-recorded as “01b” (step S18), and the value of individual time difference information LOST corresponding to the ith object is re-recorded as the value of time difference information OST that has already been set (step S19). If the check at step S10 shows that the value of type information TY is “0001h”, the values of each piece of recording start time information ST are already described in a local standard time, thus are not altered.

Next, it is checked as in step S15 if the current value of parameter i has become “n−1” or not (step S20). If the current value of parameter i is not “n−1” (step S20; NO), the value of parameter i is incremented by just “one” (step S23) to return to step S18 so that each process of steps S18 and S19 is performed to unprocessed objects. Whereas if the current value of parameter i is “n−1” (step S20; YES), all the objects previously recorded have been processed with processes of steps S18 and S19. Thus the value of type information TY which has originally been “0001h” is rewritten to “0010h” and also the value of time difference information OST is rewritten to a value not significant (step S21). Further, the values in other navigation total information NT are rewritten to corresponding values (step S22), which completes the recording process according to the embodiment.

Meanwhile, if the value of type information TY turns out to be “0010h” at step S10 (step S10; 0010h), the processes of steps S5 to S9, S11 to S15, and S21, or steps S5 to S9, S18 and S19, and S21 have already been completed, thus the process of step S22 is directly executed and the recording process according to the embodiment terminates.

Now, the process of displaying a recording start time for an object on the display unit 15 in reproducing any object from the DVD 1 in which objects have been recorded with the processes in FIGS. 3 and 4 will be described with FIG. 5.

As FIG. 5 shows, in the process of displaying a recording start time, the current content of type information TY on the DVD 1 is first examined (step S25).

If the value of type information TY is “0000h” (step S25; 0000h), no object has been previously recorded to the DVD 1 by the recorder/player S according to the embodiment, and other objects have already been recorded to the DVD 1 by another recorder/player, and the recording start time information ST for the objects have been described in GMT. Therefore, parameter i indicating the number of one of the recorded objects is initialized (step S26), and the displayed time (referring to the recording start time actually displayed on the display unit 15. The same applies to the following) corresponding to the ith object is set to a value equivalent to recording start time information ST corresponding to the ith object plus the value set as recorder time difference information at step S3 in FIG. 3 (step S27).

Then it is checked whether the current value of parameter i has become “n” or not, that is, whether or not the process of step S27 has been completed for all the objects that have been previously recorded on the DVD 1 (step S28). If the current value of parameter i is not “n” (step S28; NO), the value of parameter i is incremented by just “one” (step S29) to return to step S27 so that the process of step S27 will be executed to unprocessed objects. And if the current value of parameter i is “n” (step S28; YES), all the objects previously recorded have been processed with the process of step S27. Thus the recording start time for an object that should be reproduced with a displayed time that has been calculated at step S27 is displayed on the display unit 15 (step S30) and a series of recording start time display processes terminates.

Meanwhile, if the value of type information TY is “0001h” at the process of step S25 (step S25; 0001h), no object has been previously recorded to the DVD 1 by the recorder/player S according to the embodiment, and other objects have already been recorded to the DVD 1 by another recorder/player, and further the recording start time information ST for the objects have been described in local standard times. Therefore, parameter i indicating the number of one of the objects is then initialized (step S31), and the displayed time corresponding to the ith object is set to a value of [the value of recording start time information ST corresponding to the ith object−(the value recorded as time difference information OST−the value set as recorder time difference information at step S3 in FIG. 3)] (step S32).

Then, it is checked whether the current value of parameter i has become “n” or not, that is, whether or not all the objects previously recorded on the DVD 1 have been processed with the process of step S32 (step S33). If the current value of parameter i is not “n” (step S33; NO), the value of parameter i is incremented by just “one” (step S34) to return to step S32 so that the process of step S32 is executed to unprocessed objects. And if the current value of parameter i is “n” (step S33; YES), the process of step S32 has been completed for all the objects previously recorded. Then, the recording start time for an object that should be reproduced with a displayed time calculated at step S32 is displayed on the display unit 15 (step S30) and a series of recording start time display processes terminates.

On the other hand, if the value of type information TY is “0010h” at step S25 (step S25; 0010h), one or more objects have been previously recorded to the DVD 1 by the recorder/player S according to the embodiment. Thus the parameter i indicating the number of one of the objects is initialized (step S35), and the displayed time corresponding to the ith object is set to the value of recording start time information ST corresponding to the ith object (step S36).

Subsequently, it is checked whether the current value of parameter i has become “n” or not, that is, whether or not the process of step S36 has been completed for all the objects recorded on the DVD 1 (step S37). If the current value of parameter i is not “n” (step S37; NO), the value of parameter i is incremented by just “one” (step S38) to return to step S36 so that the process of step S36 is executed to unprocessed objects. Whereas if the current value of parameter i is “n−1” (step S37; YES), all the recorded objects have been processed with the process of step S36. Thus the recording start time for an object that should be reproduced with a displayed time calculated at step S36 is then displayed on the display unit 15 (step S30) and a series of recording start time display processes terminates.

(III) Instantiation of Recording Process

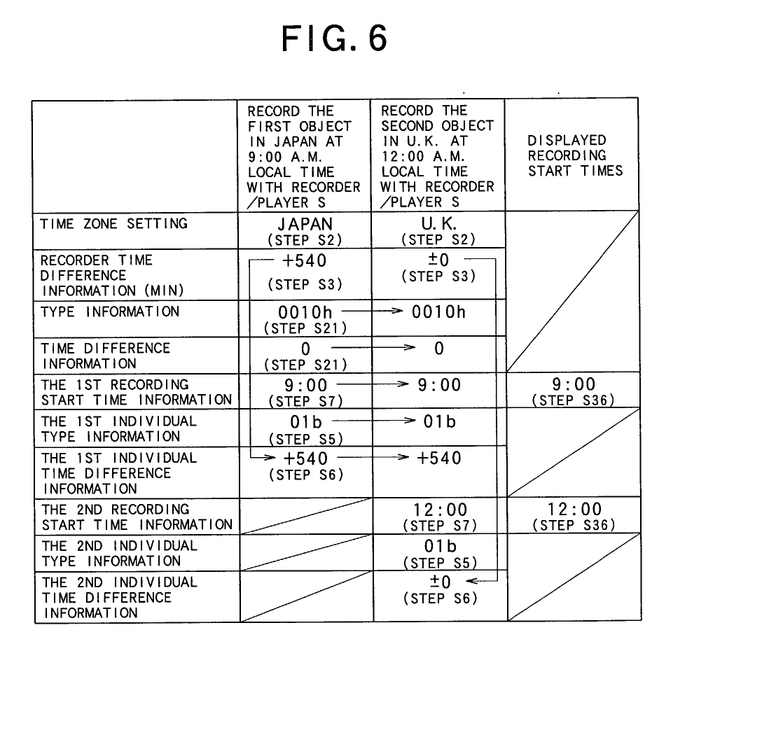

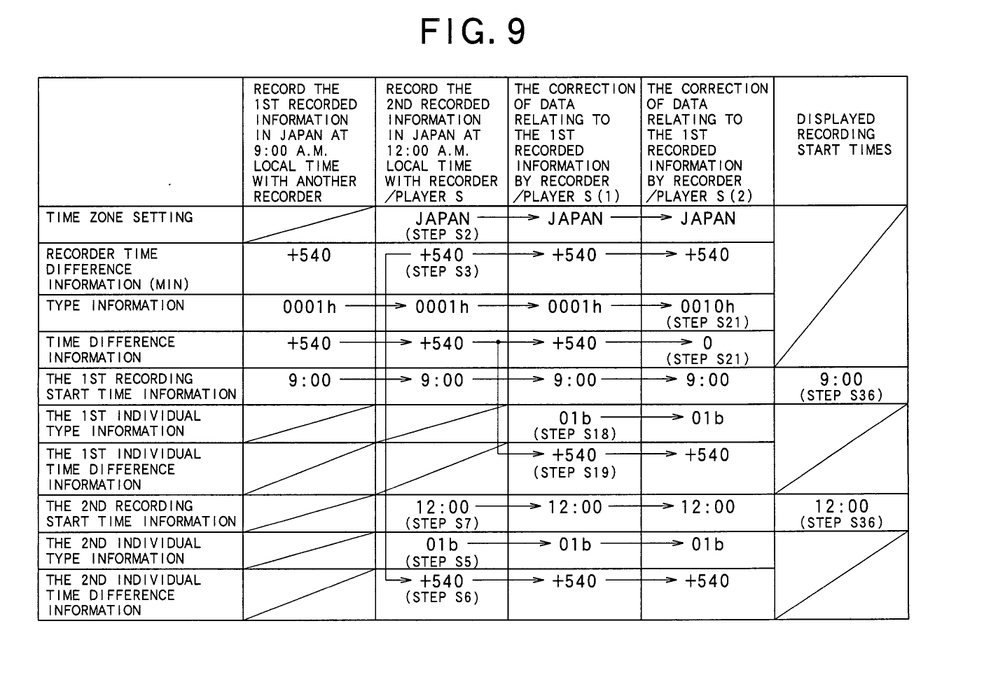

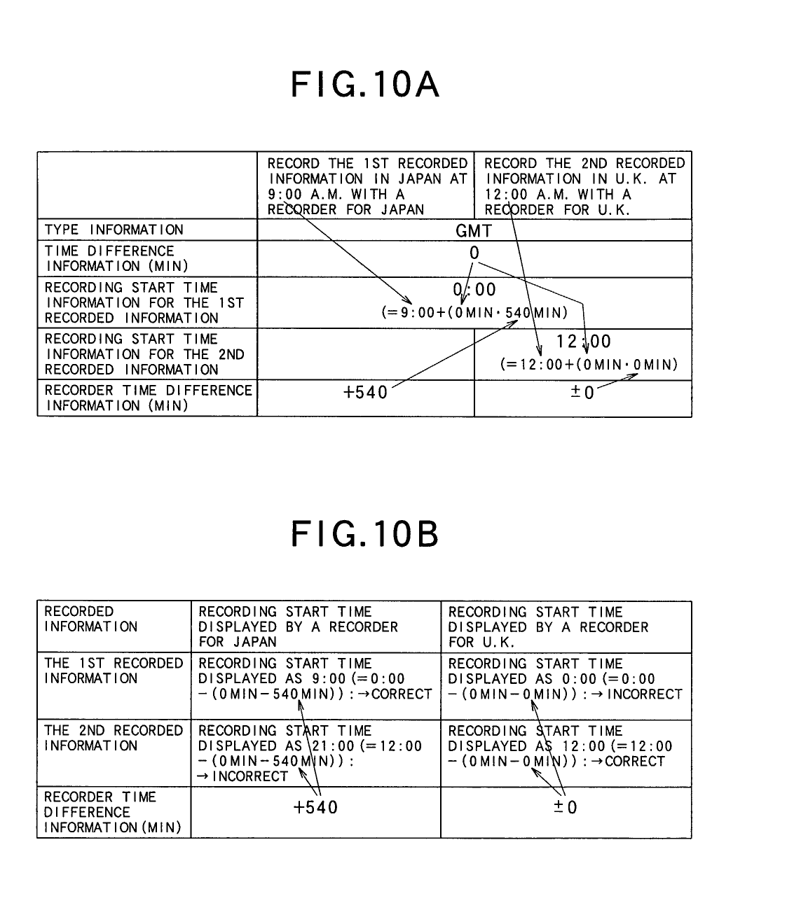

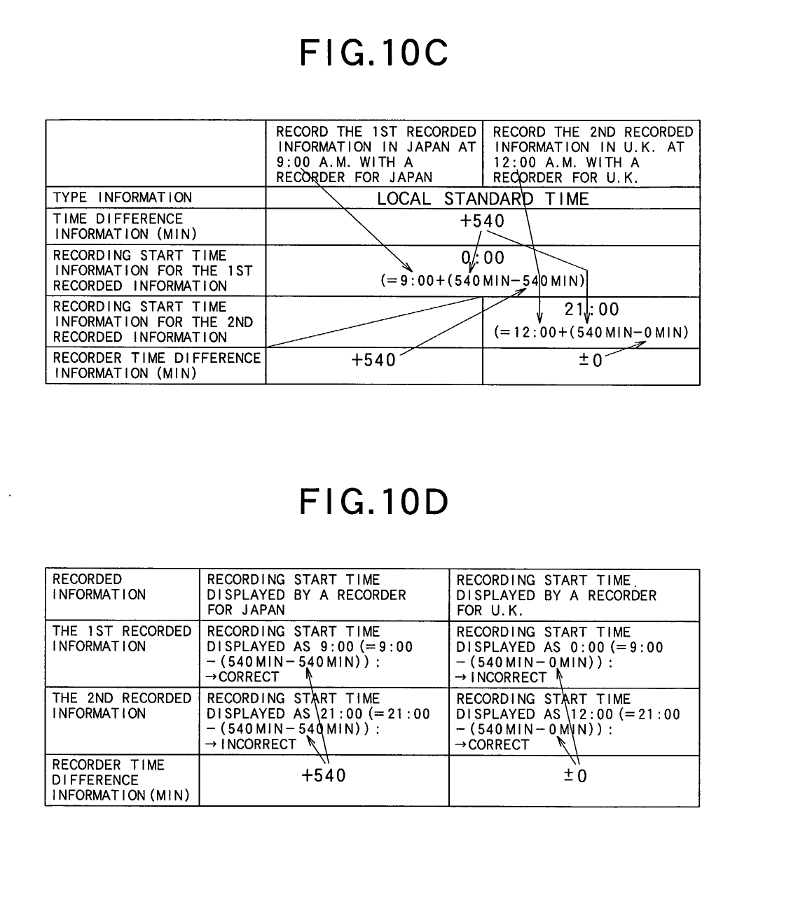

Now, specific content of information that is recorded or displayed in a series of recording processes and time displaying processes described above will be described with FIGS. 6 to 9.

FIGS. 6 to 9 specifically illustrate recording process executed in the recorder/player S according to the embodiment based on practical examples.

As the first example, change in each piece of information will be first described with FIG. 6 for a case where the first object is recorded to an unrecorded DVD 1 in Japan at 9:00 a.m. local time by a recorder/player S according to the embodiment and then the second object is recorded to the DVD 1 in U.K. at 12:00 a.m. local time by a recorder/player S.

Initially, when the first object is recorded to a DVD 1 in Japan at 9:00 a.m. local time by a recorder/player S, the country where the recording occurs is set to Japan with the process of step S2 of FIG. 3, and also the recorder time difference information is set to “+540 minutes” with the process of step S3 of FIG. 3.

And at the time the first object has been recorded (step S8 of FIG. 4), the first recording start time information ST1 has been recorded as “9:00” with the process of step S7 of FIG. 4, the first individual type information LTY1 has been recorded as “01b” with the process of step S5 of FIG. 4, and the first individual time difference information LOST1 has been recorded as “+540 minutes”, which is the current value of recorder time difference information, with the process of step S6 of FIG. 4.

Then, type information TY is recorded as “0010h” and also time difference information OST is recorded as a value not significant (“0 minutes” for example, which applies to the following) with the process of step S21 of FIG. 4.

Subsequently, when the second object is recorded to the DVD 1 in U.K. at 12:00 a.m. local time by a recorder/player S, the country where recording occurs is set to U.K. by the step S2 of FIG. 3, and also recorder time difference information is set to “±0 minutes” by step S3 of FIG. 3.

And at the time the second object has been recorded (step S8 of FIG. 4), the second recording start time information ST2 has been recorded as “12:00” by step S7 of FIG. 4, the second individual type information LTY2 has been recorded as “01b” by step S5 of FIG. 4, and the second individual time difference information LOST2 has been recorded as “±0 minutes” which is the current value of recorder time difference information by step S6 of FIG. 4. At this point, values of the first recording start time information ST1, the first individual type information LTY1, the first individual time difference information LOST1, type information TY, and time difference information OST are not subjected to any change and remain the same as at the recording of the first recorded information in Japan.

When the recording start time for each object is displayed in reproduction of objects using the each piece of recorded information, for the first object, the time will be correctly (i.e. same as the local time at which it was recorded) displayed as 9:00 a.m. by step S36 of FIG. 5, and for the second object, will be correctly displayed as 12:00 a.m. by step S36 of FIG. 5 as well.

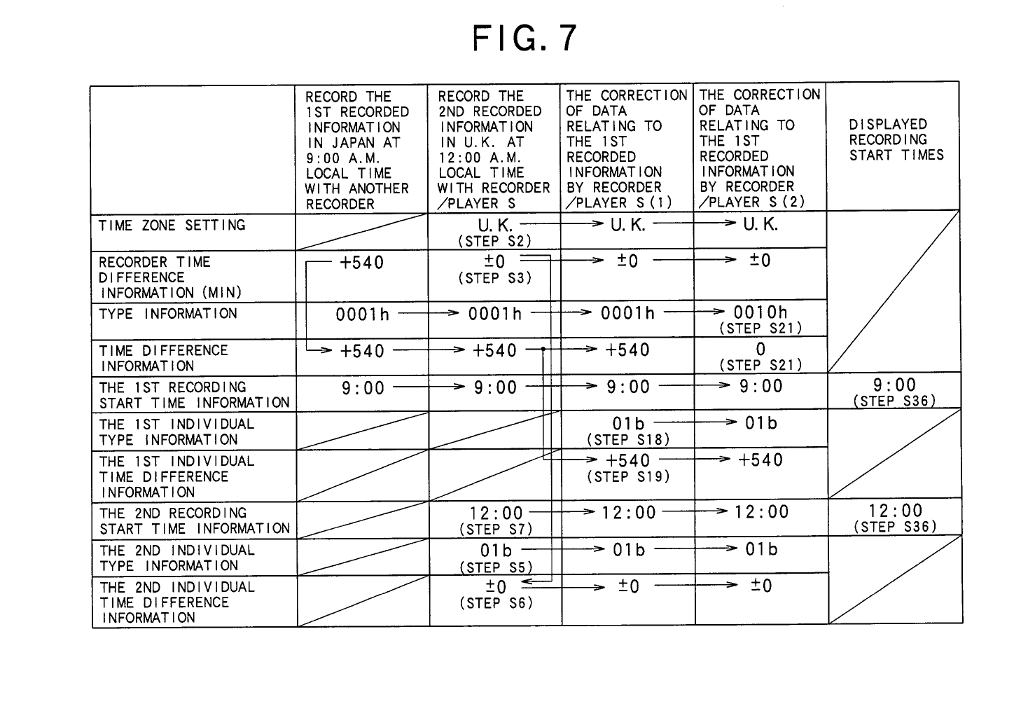

Next, as the second example, change in each piece of information will be described with FIG. 7 for a case where the first object is recorded to a DVD 1 in Japan at 9:00 a.m. of a local standard time by a recorder/player other than the recorder/player S and then the second object is recorded to the DVD 1 in U.K. at 12:00 a.m. local time by a recorder/player S.

Initially, when the first object is recorded to a DVD 1 in Japan at 9:00 a.m. local time by another recorder/player (which has recorder time difference information of “+540 minutes” in this case), recorder time difference information is recorded as “+540 minutes”, type information TY as “0001h”, time difference information OST as “+540 minutes”, and the first recording start time information ST1 as “9:00” according to prior art.

Subsequently, when the second object is recorded to the DVD 1 in U.K. at 12:00 a.m. local time by a recorder/player S, initially the country where the recording occurs is set to U.K. by the step S2 of FIG. 3, and also recorder time difference information is set to “±0 minutes” with the process of step S3 of FIG. 3.

And at the time the second object has been recorded (step S8 of FIG. 4), the second recording start time information ST2 has been recorded as “12:00” with the process of step S7 of FIG. 4, the second individual type information LTY2 has been recorded as “01b” by the step S5 of FIG. 4, and the second individual time difference information LOST2 has been recorded as “±0 minutes” that is the current value of recorder time difference information with the process of step S6 of FIG. 4. At this point, the values of the first recording start time information ST1, type information TY, and time difference information OST are not changed and remain the same as at the recording of the first recorded information in Japan.

When the second object has been recorded, information corresponding to the first object recorded in Japan is rewritten.

That is, the first individual type information LTY1 is recorded as “01b” with the process of step S18 of FIG. 4, and the first individual time difference information LOST1 is recorded as “±540 minutes” with the process of step S19 of FIG. 4. At this point, the country setting remains U.K., and the contents of recorder time difference information, type information TY, time difference information OST, the first recording start time information ST1, the second recording start time information ST2, the second individual type information LTY2, and the second individual time difference information LOST2 are not changed either.

And as subsequent rewriting of information corresponding to the first object, the type information TY is recorded as “0010h” and also the time difference information OST is recorded as a value that is not significant with the process of step S21 of FIG. 4. At this point, the country setting still remains U.K., and the contents of recorder time difference information, the first recording start time information ST1, the first individual type information LTY1, the first individual time difference information LOST1, the second recording start time information ST2, the second individual type information LTY2, and the second individual time difference information LOST2 are not changed either.

As a result, when recording start time for each object is displayed in reproducing each object using each piece of the recorded information, for the first object, the time will be correctly displayed as 9:00 a.m. by step S36 of FIG. 5, and for the second object, will be correctly displayed as 12:00 a.m. by step S36 of FIG. 5 as well.

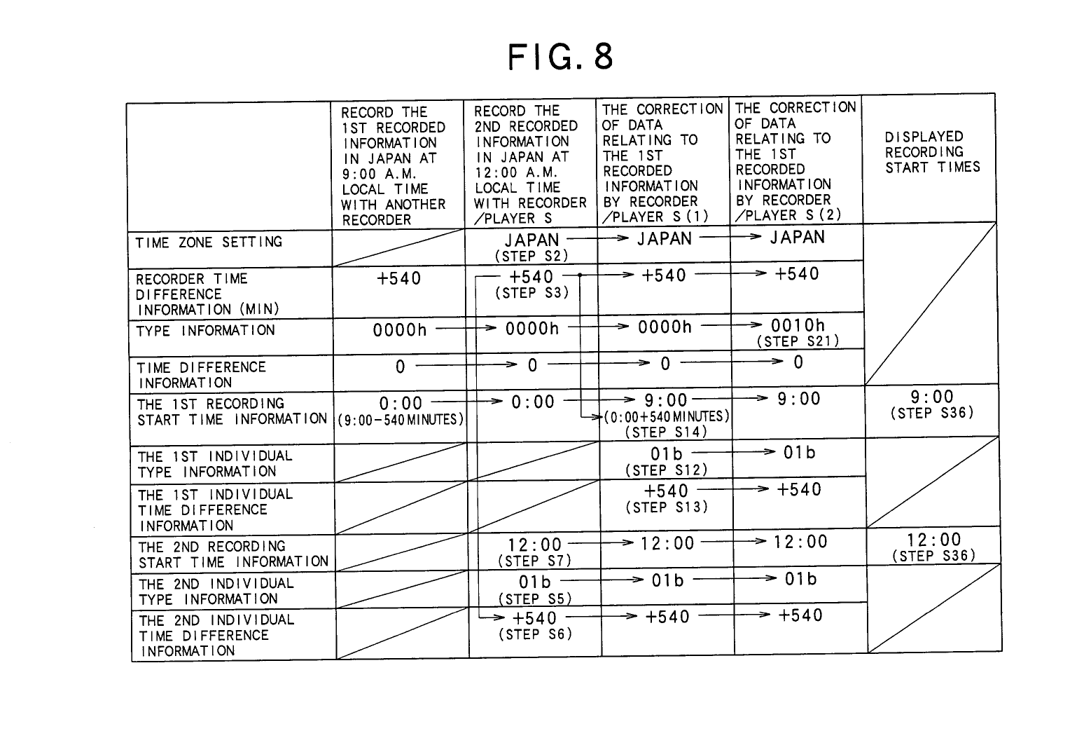

Further, as the third example, change in each piece of information will be described with FIG. 8 for a case where the first object is recorded to a DVD 1 in Japan at 9:00 a.m. local time according to GMT by a recorder/player other than the recorder/player S and then the second object is recorded to the DVD 1 in Japan at 12:00 a.m. local time by a recorder/player S.

Initially, when the first object is recorded to a DVD 1 in Japan at 9:00 a.m. local time by another recorder/player, recorder time difference information is recorded as “+540 minutes”, type information TY as “0000h”, time difference information OST as a value that is not significant, and the first recording start time information ST1 as “0:00” (recording time in local time−recorder time difference information) according to prior art.

Subsequently, when the second object is recorded to the DVD1 in Japan at 12:00 a.m. local time by a recorder/player S, the country where the recording occurs is set to Japan with the process of step S2 of FIG. 3, and recorder time difference information is set to “+540 minutes” with the process of step S3 of FIG. 3.

And at the time the second object has been recorded (step S8 of FIG. 4), the second recording start time information ST2 has been recorded as “12:00” with the process of step S7 of FIG. 4, the second individual type information LTY2 has been recorded as “01b” with the process of step S5 of FIG. 4, and the second individual time difference information LOST2 has been recorded as “+540 minutes”, which is the current value of recorder time difference information, with the process of step S6 of FIG. 4. At this point, the values of the first recording start time information ST1, type information TY, and time difference information OST are not changed and remain the same as at the recording of the first recorded information in Japan.

When the second object has been recorded, information that corresponds to the first object recorded in Japan is rewritten.

That is, the value of the first recording start time information ST1 is changed, with the process of step S14 of FIG. 4, to a value (9:00) that is equal to the first recording start time information ST1 (0:00) at the recording of the first recorded information in Japan plus the value of recorder time difference information (+540 minutes) set at step S3 of FIG. 3; the first individual type information LTY1 is recorded as “01b” with the process of step S12 of FIG. 4; and the first individual time difference information LOST1 is recorded as “+540 minutes” with the process of step S13 of FIG. 4. At this point, the country setting remains Japan, and the contents of recorder time difference information, type information TY, time difference information OST, the second recording start time information ST2, the second individual type information LTY2, and the second individual time difference information LOST2 are not changed either.

Then, as subsequent rewriting of information that corresponds to the first object, type information TY is recorded as “0010h” with the process of step S21 of FIG. 4. At this point, the country setting still remains Japan, and the contents of recorder time difference information, the first recording start time information ST1, the first individual type information LTY1, the first individual time difference information LOST1, the second recording start time information ST2, the second individual type information LTY2, and the second individual time difference information LOST2 are not changed either.

As a result, when the recording start time for each object is displayed in reproducing objects using each piece of recorded information, for the first object the time will be correctly displayed as 9:00 a.m. by step S36 of FIG. 5, and for the second object, will be correctly displayed as 12:00 a.m. by step S36 of FIG. 5 as well.

Finally, as the fourth example, change in each piece of information will be described with FIG. 7 for a case where the first object is recorded to a DVD 1 in Japan at 9:00 a.m. local time according to a local standard time by a recorder/player other than the recorder/player S and then the second object is recorded to the DVD 1 in Japan at 12:00 a.m. local time by a recorder/player S.

Initially, when the first object is recorded to a DVD 1 in Japan at 9:00 a.m. by another recorder/player, recorder time difference information is recorded as “+540 minutes”, type information TY as “0001h”, time difference information OST as “+540 minutes”, and the first recording start time information ST1 as “9:00” in accordance with prior art.

Subsequently, when the second object is recorded to the DVD 1 in Japan at 12:00 a.m. local time by a recorder/player S, the country where the recording occurs is set to Japan with the process of step S2 of FIG. 3, and recorder time difference information is set to “+540 minutes” with the process of step S3 of FIG. 3.

At the time the second object has been recorded (step S8 of FIG. 4), the second recording start time information ST2 has been recorded as “12:00” with the process of step S7 of FIG. 4, the second individual type information LTY2 has been recorded as “01b” with the process of step S5 of FIG. 4, and the second individual time difference information LOST2 has been recorded as “+540 minutes” that is the current value of recorder time difference information with the process of step S6 of FIG. 4. At this point, the values of the first recording start time information ST1, type information TY, and time difference information OST are not changed and remain the same as at the recording of the first recorded information in Japan.

When the second object has been recorded, information that corresponds to the first object recorded in Japan is rewritten.

That is, the first individual type information LTY1 is recorded as “01b” with the process of step S18 of FIG. 4, and the first individual time difference information LOST1 is recorded as “+540 minutes” with the process of step S19 of FIG. 4. At this point, the country setting remains Japan, and the contents of recorder time difference information, type information TY, time difference information OST, the first recording start time information ST1, the second recording start time information ST2, the second individual type information LTY2, and the second individual time difference information LOST2 are not changed either.

Then, as subsequent rewriting of information that corresponds to the first object, type information TY is recorded as “0010h”, and also time difference information OST is recorded as a value that is not significant with the process of step S21 of FIG. 4. At this point, the country setting still remains Japan, and the contents of recorder time difference information, the first recording start time information ST1, the first individual type information LTY1, the first individual time difference information LOST1, the second recording start time information ST2, the second individual type information LTY2, and the second individual time difference information LOST2 are not changed either.

As a result, when recording start time for each object is displayed in reproducing objects using each piece of recorded information, for the first object the time will be correctly displayed as 9:00 a.m. by step S36 of FIG. 5, and for the second object, will be correctly displayed as 12:00 a.m. by step S36 of FIG. 5 as well.

As have been described, since the recorder/player S according to the embodiment operates such that it records individual time difference information LOST for each object and also records type information TY as “0010h”, it is possible to correctly manage time differences to be applied to each object based on the content of type information TY, even if multiple objects that should correspond to distinct time differences are recorded to a single DVD 1.

Also, by rewriting the content of type information TY to “0010h” and also recording individual time difference information LOST associated with an object when recording an object that should correspond to a time difference distinct from the one indicated by time zone information TZ, it is possible to correctly manage time differences to be applied to each object based on the content of type information TY, even if multiple objects that should correspond to distinct time differences are recorded to a single DVD 1.

Moreover, by separately recording individual time difference information LOST that other objects already recorded should correspond to, it is possible to correctly manage time differences also for other objects already recorded.

Further, since corresponding recorder time difference information can be input through the operation unit 6, it is possible to set and use a correct time difference even when different pieces of recorded information are recorded in countries or areas that correspond to distinct time differences.

Also, by detecting individual time difference information LOST when it is recognized that type information TY of the value “0010h” is recorded and outputting recording start time corresponding to the individual time difference information LOST based on the detected information, it is possible to output and use a correct recording start time corresponding to an object to be reproduced even when any object is reproduced from a DVD 1 on which multiple objects that should correspond to distinct time differences are recorded.

It is also possible to record the program corresponding to the flow charts shown in FIGS. 3 to 5 on an information record medium such as a flexible disk or a hard disk or distribute it over a network such as the Internet to be executed by a generic microcomputer or the like, so that the microcomputer or the like functions as the system controller 7 according to the embodiment.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-303349 filed on Sep. 28, 2001 including the specification, claims, drawings and summary is incorporated herein by reference in its entirety.

What is claimed is:

1. An information recording device, comprising:
a recording device for recording recorded information onto a record medium; and
an individual area time difference information recording device for recording individual area time difference information onto said record medium, the individual area time difference information indicating a time difference to be applied to said recorded information for each piece of recorded information.

2. The information recording device according to claim 1, further comprising a general area time difference information recording device for recording specific general time difference information onto said record medium, the specific general time difference information indicating that said individual area time difference information is recorded on said record medium.

3. The information recording device according to claim 1, further comprising an input device for inputting said individual area time difference information based on the time difference to be applied to said recorded information to be recorded.

4. An information recording device, comprising:
a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information;
a recording device for recording said additional recorded information onto said record medium; and
an individual area time difference information recording device for recording individual area time difference information onto said record medium.

5. The information recording device according to claim 4, wherein said rewriting device records said individual area time difference information onto said record medium that indicates a time difference to be applied to said other pieces of recorded information already recorded on said record medium independently of said specific general time difference information.

6. The information recording device according to claim 4, further comprising an input device for inputting said individual area time difference information based on the time difference to be applied to said recorded information to be recorded.

7. An information reproducing device for reproducing each piece of recorded information from a record medium, the record medium comprising:
recorded information recording area on which each piece of said recorded information is recorded; and
individual area time difference information recording area on which individual area time difference information, the individual area time difference information indicating a time difference to be applied to said recorded information for each piece of recorded information;
said information reproducing device comprising:
an output device for outputting time information based on said individual area time difference information.

8. The information reproducing device according to claim 7, wherein
said record medium further comprising:
general area time difference information recording area on which specific general time difference information is recorded, the specific general time difference information indicating that said individual area time difference information is recorded on said record medium;
said information reproducing device further comprising:
a verification device for verifying whether said specific general time difference information is recorded on said record medium or not; and
said output device for outputting time information based on said individual area time difference information when said specific general time difference information is recorded.

9. An information recording method, comprising:
a recording step of recording recorded information onto a record medium; and
an individual area time difference information recording step of recording individual area time difference information onto said record medium, the individual area time difference information indicating a time difference to be applied to said recorded information for each piece of the recorded information.

10. The information recording method according to claim 9, further comprising a general area time difference information recording step of recording specific general time difference information onto said record medium, the specific general time difference information indicating that said individual area time difference information is recorded on said record medium.

11. The information recording method according to claim 9, further comprising an input step of inputting said individual area time difference information based on the time difference to be applied to said recorded information to be recorded.

12. An information recording method, comprising:
a rewriting step of, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information;
a recording step of recording said additional recorded information onto said record medium; and
an individual area time difference information recording step of recording individual area time difference information onto said record medium.

13. The information recording method according to claim 12, wherein said rewriting step records said individual area time difference information onto said record medium that indicates a time difference to be applied to said other pieces of recorded information already recorded on said record medium independently of said specific general time difference information.

14. The information recording method according to claim 12, further comprising an input step of inputting said individual area time difference information based on the time difference to be applied to said recorded information to be recorded.

15. An information reproducing method for reproducing each piece of recorded information from a record medium, the record medium comprising:
recorded information recording area on which each piece of said recorded information is recorded; and
individual area time difference information recording area on which individual area time difference information, the individual area time difference information indicating a time difference to be applied to said recorded information for each piece of recorded information;
said information reproducing method comprising:
an output step of outputting time information based on said individual area time difference information.

16. The information reproducing method according to claim 15, wherein
said record medium further comprising:
general area time difference information recording area on which specific general time difference information is recorded, the specific general time difference information indicating that said individual area time difference information is recorded on said record medium;
said information reproducing method further comprising:
a verification step of verifying whether said specific general time difference information is recorded on said record medium or not; and
said output step of outputting time information based on said individual area time difference information when said specific general time difference information is recorded.

17. An information record medium on which a record controlling program is recorded being readable by a recording computer that is included in an information recording device, said program causing said recording computer to function as:
a recording device for recording recorded information onto a record medium; and
individual area time difference information recording device for recording individual area time difference information onto said record medium, the individual area time difference information indicating a time difference to be applied to said recorded information for each piece of recorded information.

18. The information record medium according to claim 17, further causing the recording computer to function as:
a general area time difference information recording device for recording specific general time difference information onto said record medium, the specific general time difference information indicating that said individual area time difference information is recorded on said record medium.

19. The information record medium according to claim 17, further causing the recording computer to function as an input device for inputting said individual area time difference information based on the time difference to be applied to said recorded information to be recorded.

20. An information record medium on which a record controlling program is recorded being readable by a recording computer that is included in an information recording device, said program causing said recording computer to function as:
a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information;
a recording device for recording said additional recorded information onto said record medium; and
an individual area time difference information recording device for recording individual area time difference information onto said record medium.

21. The information record medium according to claim 20, wherein said rewriting device records said individual area time difference information onto said record medium that indicates a time difference to be applied to said other pieces of recorded information already recorded on said record medium independently of said specific general time difference information.

22. The information record medium according to claim 20, wherein said record controlling program is recorded on the information record medium being readable by said recording computer, said record controlling program causing said recording computer to further function as input device for inputting said individual area time difference information based on the time difference to be applied to said recorded information to be recorded.

23. An information record medium on which a reproduction controlling program is recorded being readable by a reproducing computer that is included in an information reproducing device which reproduces each piece of recorded information from a record medium, the record medium comprising:
recorded information recording area on which each piece of said recorded information is recorded; and
individual area time difference information recording area on which individual area time difference information, the individual area time difference information indicating a time difference to be applied to said recorded information for each piece of recorded information;
said reproduction controlling program causing said reproducing computer to function as:
an output device for outputting time information based on said individual area time difference information.

24. The information record medium according to claim 23, wherein
said record medium further comprising:
general area time difference information recording area on which specific general time difference information is recorded, the specific general time difference information indicating that said individual area time difference information is recorded on said record medium;
said reproduction controlling program further causing said reproducing computer to function as:
a verification device for verifying whether said specific general time difference information is recorded on said record medium or not; and
said output device for outputting time information based on said individual area time difference information when said specific general time difference information is recorded.

25. A record controlling program embodied on computer-readable medium for causing a recording computer included in an information recording device to function as:
a recording device for recording recorded information onto a record medium; and
an individual area time difference information recording device for recording individual area time difference information onto said record medium, the individual area time difference information indicating a time difference to be applied to said recorded information for each piece of recorded information.

26. The record controlling program according to claim 25, further causing the recording computer to function as: a general area time difference information recording device for recording specific general time difference information onto said record medium, the specific general time difference information indicating that said individual area time difference information is recorded on said record medium.

27. The information record program according to claim 25, further causing the recording computer to function as an input device for inputting said individual area time difference information based on the time difference to be applied to said recorded information to be recorded.

28. A record controlling program embodied on computer-readable medium for causing a recording computer included in an information recording device to function as:
a rewriting device for, when additionally recording additional recorded information onto a record medium, rewriting recorded general area time difference information, indicating a time difference corresponding to all of recorded information recorded on the record medium, to specific general time difference information, indicating a time difference to be applied to said recorded information for each piece of recorded information;
a recording device for recording said additional recorded information onto said record medium; and
an individual area time difference information recording device for recording individual area time difference information onto said record medium

29. The record controlling program embodied on computer-readable medium according to claim 28, wherein the record controlling program causes said recording computer to function as said rewriting device for recording individual area time difference information onto said record medium that indicates a time difference to be applied to other pieces of said recorded information already recorded on said record medium independently of said specific general time difference information.

30. The record controlling program embodied on computer-readable medium according to claim 28, wherein the record controlling program causes said recording computer to further function as input device for inputting said individual area time difference information based on a time difference to be applied to said recorded information to be recorded.

31. A reproduction controlling program embodied on computer-readable medium for causing a reproducing computer that is included in an information reproducing device for reproducing each piece of said recorded information from said record medium, the record medium comprising:
recorded information recording area on which each piece of said recorded information is recorded; and
individual area time difference information recording area on which individual area time difference information, the individual area time difference information indicating a time difference to be applied to said recorded information for each piece of recorded information;
said reproduction controlling program causing said reproducing computer to function as:
an output device for outputting time information based on said individual area time difference information.

32. The reproduction controlling program according to claim 31, wherein
said record medium further comprising:
general area time difference information recording area on which specific general time difference information is recorded, the specific general time difference information indicating that said individual area time difference information is recorded on said record medium;
said reproduction controlling program causing said reproducing computer to function as:
a verification device for verifying whether said specific general time difference information is recorded on said record medium or not; and
said output device for outputting time information based on said individual area time difference information when said specific general time difference information is recorded.

33. A record medium, comprising:
recorded information recording area on which each piece of said recorded information is recorded; and
individual area time difference information recording area on which individual area time difference information, the individual area time difference information indicating a time difference to be applied to said recorded information for each piece of recorded information.

34. The record medium according to claim 33, further comprising:
general area time difference information recording area on which specific general time difference information is recorded, the specific general time difference information indicating that said individual area time difference information is recorded on said record medium.
